(19) United States
(12) Patent Application Publication
(10) Pub. No.: US 2004/0098256 A1
(43) Pub. Date: May 20, 2004

(54) Tactile communication system

(76) Inventor: John Christian Doughty Nissen, London (GB)

Correspondence Address: FAY KAPLUN & MARCIN, LLP, 15O BROADWAY, SUITE 702, NEW YORK, NY, 10038, US

(21) Appl. No.: 10/465,963

(22) PCT Filed: Dec. 31, 2001
(86) PCT No.: PCT/GB01/05794

(30) Foreign Application Priority Data
Dec. 29, 2000 (GB) 0031840.2

(51) Int. Cl. G10L 19/10

(52) U.S. Cl. 704/220

(57) ABSTRACT

This invention concerns a system of communication including a tactile device for single-handed input of phonetic information and a corresponding tactile device for output of that information onto a single hand. The phonetic information input using the tactile input device can be output as synthesized speech, and the tactile output device can receive phonetic information obtained from a speech recognition engine. Thus the input device acts as a “talking hand”, and the output device acts as a “listening hand”. The phonemic information is suitable for tactile or speech output, either directly or indirectly, locally or remotely, via a transmission system such as a telephone network. The system involves a scheme in which the fingers are used for consonants and the thumb for vowels, with fingers and thumb used together for voiced consonants.

### BACKGROUND

Hitherto there have not been any successful systems for rapid communication between deafblind individuals, or for generating speech by mute or speech impaired people.

There have been systems for deafblind people based on Braille or on manual alphabets, for example the Instrumented Glove, by Kramer U.S. Pat. No. 5,047,952.

This invention takes a new approach by using phonemes as a basis for communication.

It competes with chordal input systems by allowing immediate aural feedback.

1. Introduction

This invention concerns a system of communication including a tactile device for single-handed input of phonetic information and a corresponding tactile device for output of that information onto a single hand. The phonetic information input using the tactile input device can be output as synthesised speech, and the tactile output device can receive phonetic information obtained from a speech recognition engine. Thus the input device acts as a “talking hand”, and the output device acts as a “listening hand”. The phonemic information is suitable for tactile or speech output, either directly or indirectly, locally or remotely, via a transmission system such as a telephone network.

The system involves a scheme in which the fingers are used for consonants and the thumb for vowels, with fingers and thumb used together for voiced consonants. For input, there are digit movements or positions which are recognised singly or in combination as particular phonetic sounds, phonemes or allophones. The input device may be realised using buttons, keys or a tactile surface. For output, there are positions or loci of movement or vibration. The output device may be realised using moving or vibrating pins. However the vowel input may be also realised by a touch sensitive surface, and the vowel output by a tilting platform.

The system has been designed for maximum speed of operation, so that the input device can be operated at a natural talking speed, and output can be recognised at a similar speed.

The scheme itself can be used for direct manual tactile communication, in which the hand of the “sender” touches the hand of the “receiver”, e.g. for communication between deafblind people. The invention is designed to emulate this direct manner of communication, such that the input device is operated as if it were a receiving hand, receiving information directly from the sender. Conversely, the output device is operated as if it were a sending hand, imparting information directly to the receiver.

Furthermore the invention is designed so that the movements of the digits of the sending hand correspond in a direct way to the movement of the tongue in the mouth to produce the same speech sound. In this way, the brain should find a mapping and a correspondence between the tactile and acoustic domains, and learn both to use the speech generation facility of the brain to activate the hand instead of the tongue. Conversely, the output device is designed and to use the speech recognition facility to activate the hand tactile sensors recognition instead of the ear. Thus the input and output devices should become natural to operate, and fast to use.

In general speech synthesisers convert a string of alphabetic characters into a stream of phonemes, and speech recognition engines do the converse. The basis of this invention is phonemic rather than strictly phonetic, as this allows users to hear the phonetic information presented with their own accent, given a speech synthesiser for that accent. This phonetic information may have been generated by the tactile input or speech input of somebody with a different accent. Thus in general the invention allows communication between people of different accents. However if an accent has one phoneme where RP has two, there obviously is a problem—for example Scottish has the same phoneme for ‘cot’, and ‘caught’, compared to two phonemes in RP, Cockney has /f/ for both ‘fin’ and ‘thin’, Yorkshire has the same phoneme for ‘cud’ and ‘could’, etc. Conversely Welsh has two phonemes for “wait” and “weight”, where RP has one, and Tyneside has two phonemes for “fork” and “talk” where RP has one.

The invention is designed to be suitable for use with European languages, and adaptable by the same principles to any other language. Optional features of stress and pitch control allow for speech inflection and adaptation for tonal languages.

The tactile input device can be used for the input of phonemic information to a processor, which can transmit the information to another processor where the phonemic information can be displayed using visual display, speech synthesiser, or a tactile output device. This allows remote communication via phone network or internet.

In typical embodiments of the invention, there are buttons (or keys) on the input device, which are pressed by the sending person, and there are corresponding pins on the output device, which vibrate to impart information in a tactile form to the receiving person.

In typical embodiments, the tactile input device can generate an immediate speech output. The sound output (typically a phoneme segment) can be produced in almost immediate response to a user operation. The user movement which is recognised as an “operation” may be the movement of the thumb across a touch-sensitive tablet, the depressions of a button (Down), or the release of a button (Up).

Juxtaposition or overlap of operations represent transitions between phonemes, or “co-articulation”, where the end of the sound of one phoneme is influenced by the beginning of the next phoneme, and/or vice versa. This allows the generated speech to have high intelligibility, because of the presence of subtle sound cues which help the listener to segment the audio stream and categorise sounds into distinct phonemes.

Because of the one-handed operation with relatively few transducers, the system is suitable for use with wearable computers and mobile devices, and for use at home, at a place of education, in a public building, or while travelling, shopping, etc.

Learning the phonemic operation of the system gives the user an awareness of the phonetic basis of the language, which is helpful for learning how to read and spell the written language (especially for dyslexic children) and how to listen to and speak the spoken language (especially for people who do not have the language as their mother tongue).

2. Tactile input-output: button and pin arrangement

The same arrangement can be used for both input and output.

In general the cost of a tactile output device rises steeply with the number of moving or vibrating pins, therefore this embodiment is designed to minimise the number of pins.

In this embodiment there are four pins for the thumb and a pair for each of the fingers for output, plus preferably an extra pin for W on the first finger, and for Y on the little finger. (It is possible to avoid these extra pins by having an extra state for the pair, e.g. vibrating them together and/or using a different vibration frequency.) There are corresponding buttons or keys for input with fingers, plus preferably an extra two keys, for W and Y. For vowel input on the thumb, there are keys or buttons for producing the 8 English pure (monophthong) vowel sounds, plus optionally two extra for [oo] and [ee], effectively duplicating the sounds of W and Y respectively. Alternatively the vowel input can employ a mechanism for pointing at any point in vowel space, in which case diphthongs can be produced by moving the point in the vowel space from one vowel position to another.

A basic aspect of this invention is that the fingers are used for consonants, and the thumb is used for vowels and for voicing the consonants.

The vowel sound production and recognition is based on the conventional positioning of sounds in a quadrilateral: with vowels at the ‘front’ of the mouth on the left ‘back’ of the mouth on the right, ‘close’ at the top, and ‘open’ at the bottom.

Consider the arrangement of four pins for the output device. The thumb must be able to simultaneously feel all four pins for depression or vibration (depending on the technology). To be able to recognise any phonetic vowel sound, the user must be able to sense depression anywhere in the rectangle formed by the buttons. Correspondingly, to be able to input any phonetic vowel sound, the thumb needs to be able to slide around smoothly within that area. A plate or a touchpad might replace the buttons for the thumb. Similarly a tilting device could replace the set of four pins for the output.

3. Arrangement for optimised output

The vowels are produced by moving the thumb in “vowel space”, which is traditionally represented as a quadrilateral—something between a square and a rhomboid—with the neutral “schwa” sound (as in “er”) in the middle:

| beet | boot |
|---|---|
| (close front) | (close back, rounded lips) |
| put | |
| bit bought | |
| learn | |
| (central) | |
| bet cot | |
| cut | |
| bat calm | |
| (open front) | (open back) |

Using 4 pins for output and using adjacent pins in combination, there are 8 indications for pure vowel sounds. The short u in cut is close to the long a in calm, so we can treat them as the same vowel sound. The consonant Y is used to obtain [ee], and W to obtain [oo] as in boot, see below. One can add a Y or a W at the beginning or end of a vowel to produce a diphthong. Similarly R can be added at the end of a vowel for a schwa ending to a diphthong, or for ‘r-colouring’ in rhotic accents.

The consonants and consonant pairs (voiced and unvoiced) are produced with 2 or 3 pins per finger, as follows:

| 1^{st} | | 2^{nd} | | 3^{rd} | | 4^{th} (little finger) |
|---|---|---|---|---|---|---|
| P/B | M | T/D | N | K/G | Ng | L |
| F/V | Th/Thv | S/Z | Sh/Zh | H | Ch/Chv | R |
| W | | | | | | Y |

where certain consonants (M, N, etc.) are represented by a combination of pins on adjacent fingers. For input, there can be a separate key or button for each of them.

The ‘liquids’ Y, W, L and R produce vowel modifications or colourings when used in combination with the thumb. They are generally self-voicing when by themselves, but immediately following an unvoiced plosive, R and L may take on an unvoiced allophone.

The Thv is the voiced fricative as in “thither”. The Zh is the voiced fricative like the ‘s’ in “measure”. The Ch is the unvoiced fricative in “loch”; and Chv is the voiced equivalent.

Note that the equivalent sound production in the mouth progresses from lips on left, to back of the throat on the right, with exception of nasals, L (lateral), H, R and Y. The place of H depends on the vowel that follows—if the H is held on, the system may produce a whisper if that is supported by the synthesiser. Note that in English, the /h/ phoneme only occurs at the beginning of syllables.

Y makes a [ee] sound as in ‘beet’ and in a ‘y’ consonant, and W makes a [oo] sound as in ‘boot’ and in a ‘w’ consonant. For input of certain words it may be necessary to move the hand slightly, e.g. so that the second finger is on the ‘b’ of “bee” instead of the first finger (which is on the Y), or so that the third finger is on the ‘l’ of “loo” instead of the little finger (which is on the W).

4. Timing of sound production

Timing of production is dependent on the precise timing of finger and thumb movement, since responses are to be immediate: You (the user) are in absolute control, as if you were talking.

The consonants on the upper row have a definite ending. The phonemes P, T, and K are plosives, where the sound in preceded by silence. The ending sound is produced as you lift the finger (or fingers in the case of nasals). If at the same time you have a vowel with your thumb, the consonant will be voiced. For a voiced consonant at the end of a word, the thumb must come off as, or immediately after, the finger is lifted.

M by itself produces a humming sound, until the fingers are lifted. If the both P and T buttons are lifted at the same time you get an /n/ phoneme ending. If P/B is later you get /mp/ or /mb/.

N by itself produces a similar humming sound, until the fingers are lifted. If both T/D and K/G buttons are lifted at the same time, you get a /n/ ending. If T/D is later you get/nt/ or /nd/.

Similarly Ng by itself also produces a humming sound, until the fingers are lifted. If K/G is later you get “nk” or “ng-g” as in “ink” or “anger”. Note that you seem to hear an n, m or ng sound dependent on the context. For example you would hear “skimp”0 and “unfounded” even though somebody said “skinp” and “umfounded” (though lip-readers would notice a difference).

To distinguish “tingle” from “tinkle”, the ‘i’ is held down until the plosive, ‘g’, to ensure that it is voiced. Similarly the vowel is held down through the liquid until the plosive to distinguish “and” from “ant”, “bold” from “bolt”, “ulb” from “ulp”, etc.

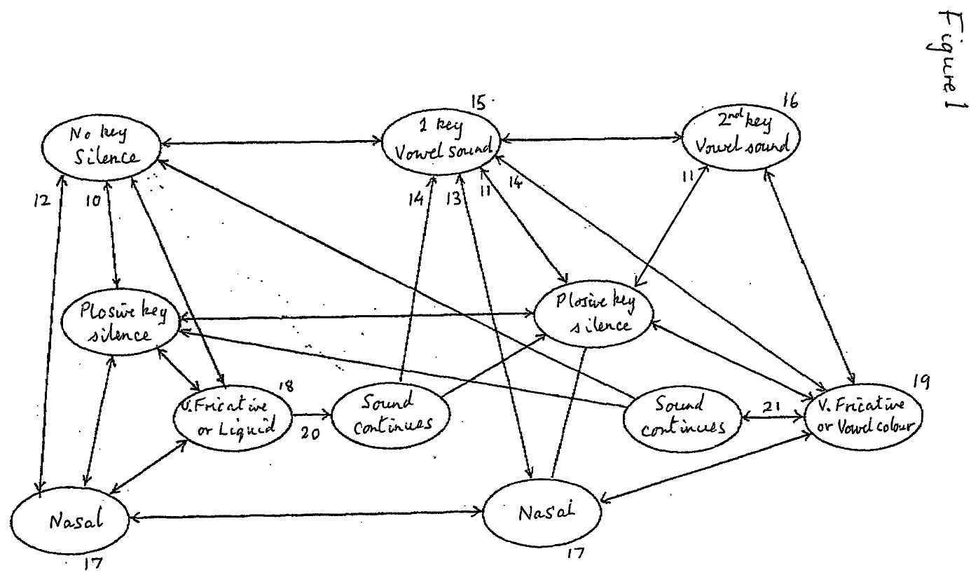

A state diagram is shown in FIG. 1, showing the various sounds and silences as keys are depressed and released. Some sounds (unvoiced plosives 10, voiced plosives 11, nasal flaps 12 and 13, and other stop sounds 14) are produced during transitions between states. Other sounds (vowels 15 and 16, nasals 17, unvoiced fricatives or liquids 18, and voiced fricatives and vowel colours 19) are produced for the duration of the state. Fricatives and liquids may be ‘locked’ so that the sound continues despite the addition 20 or subtraction 21 of a vowel key. In the latter case the vowel may be replaced by a different vowel while the voiced fricative continues; however the colour will change as appropriate for the new vowel.

When a second vowel key is depressed 16 following a first vowel key 15, the sound of the second vowel takes over from the first, until the second key is released. This allows for the production of diphthongs. Vowels here include the [ee] and [oo] which may be on Y and W keys.

There are corresponding states for the tactile output device driven by the incoming phonetic information. Each state, except the ‘no key’ state, presents an individual indication to the user such that all the various phonemes can be recognised.

5. Tactile input-output embodiments with surfaces

The above embodiments employ buttons for input and pins for output. Other embodiments employ different mechanisms in place of, or in addition to, buttons for input or pins for output.

On the input side, the digit input can be realised as a touch-sensitive surface over which the digit moves. The position of the digit and the degree of depression onto the surface can be detected by resistive, capacitative or optical means. Alternatively there can be a platform with transducers at the vertices, which allow the position and degree of depression to be detected, allow a continuous change in sound, corresponding to changes in the position of the tongue in speech production. This is particularly relevant for vowel sounds, where the thumb would move over a continuous vowel “space”.

With such an embodiment it is possible to produce all vowel sounds, where one can discriminate with reasonable resolution over the “vowel space” for 9 cardinal vowels of the IPA (International Phonetic Alphabet) and their “rounded lip” counterparts (produced by adding W), see [1] page 108.

Of the 18 cardinal vowels “some French accents” have 11, see [1] page 218. This is an exceptionally large number. The commonest vowel system has 5, such as Spanish, see [1] page 216.

6. Inflection and intonation

An embodiment of the input device which can detect velocity on keystrokes, or varying pressure on a tactile surface, allows the input of varying stress on vowels and/or consonants.

This allow the system to deal directly with accentuation of vowels to distinguish say between con'tent (happy) and 'content (that which is contained), see [1] page 195. The user could lengthen the stressed vowel, or its associated n, but it may be better to stress the consonant.

There could be an increase the stress on plosives by holding down the button longer before releasing. For example one could hold down the c or t before the vowels o or e in “content” to obtain different stresses in the word and thus distinguish the two meanings. Alternatively one could hold down the initial vowel, such as “o” for “object” to show the stress, where “object” is a noun.

The stress on plosives could be imparted to the following vowel, even with a non-plosive consonant between—for example stressing p in 'present to distinguish it from pre'sent.

In one embodiment of the invention it is possible to use a rotation for controlling pitch and volume, with a sensor on, say, the back of the hand. Pitch can be controlled by twisting the hand, to the right (clockwise) to increase, the left (anticlockwise) to decrease, e.g. for tonal languages. Volume could be controlled by raising and lowering the hand relative to the wrist, as one would do in waving goodbye.

For this implementation, there is a means to attach the input device to the hand which is doing the input. A virtual reality glove might be used for input sensing movement of each digit. Such a glove could also be used for output applying forces to each digit in the same directions as the corresponding input motion.

7. State transition diagram

FIG. 1 shows a state diagram showing the states of output of the sound generator, and transitions produced by keys being down (D) or up (U). Some states are producing a sound of defined length. These are marked with a rectangle round them. As these sounds are initiated it is necessary to determine whether there is a defined vowel to follow; and if there isn't, the schwa is produced.

Top left of diagram there is an initial state with no keys down, and silence from the generator. To the right is a state of producing a vowel sound. The vowels may be the first segment of a diphthong, and the second segment will take over immediately.

Vowels here include W [oo] and Y [ee], though these are generally operated by the fingers like consonants. They are used as segments of diphthongs, together with R acting as [er] for non-rhotic accents.

Thus “you” would be /ee,ou/ or /ee,er,oo/ in some accents. The [ou] may overlap the [ee], in which case the “ou” takes over immediately.

The consonants are shown in the diagram in unvoiced/voiced pairs. The plosives start with a state of silence as soon as the key is depressed (but see nasals), and finish with a plosive sound as the key is released. If voiced, the plosive sound merges into a vowel sound.

Nasals produce a humming sound while a pair of plosive keys are depressed. The ‘stop’ of the nasal is produced if the keys are released together. But if one of the plosive key is released first the silent plosive state begins immediately for the other plosive.

In general, one consonant takes over immediately from any other or from a vowel. This is shown by the direct “lateral” links between their down states on the diagram. There is a general rule that a voiced state always changes to a voiced state, and an unvoiced to an unvoiced. For example “frazzled” has /z,l,d/ all voiced. And “fives” has a /z/ for the s, and is an example of one voiced fricative changing to another. On the other hand “fifths” has three unvoiced fricatives together.

To allow one voiced fricative to have a different vowel on each side, as in “fiver”, there is a ‘locking’ mechanism, with an intermediate “voiced fricative” state, until a new vowel takes over.

This is an example where there is no clear syllabic boundary, since you could equally have “fi-ver” or “fiv-er”. However in general, where there is an obvious syllable boundary, there will be a moment when no keys are down, which is the top left state. There also needs to be a gap between an unvoiced consonant and the onset of a vowel sound, and the top left state is also used. For the case of a vowel being down at the end of a voiced consonant, the top right hand state is immediately obtained after the consonant sound terminates.

8. Simple embodiment using two keypads

In this embodiment there is a thumb-operated key for all the “pure” vowel sounds, except /y/ of “beet” and /w/ of “boot” which are operated by the fingers:

| beet | boot |
|---|---|
| (close front) | (close back, rounded lips) |
| could | |
| bit caught | |
| stern | |
| (central) | |
| bet cot | |
| cut | |
| bat ah | |
| (open front) | (open back) |

This suggests a layout:

[ee] [oo]
[i] [ou] as in should
[e] [er] [aw] as in paw
[a] [ah] [o]
[u]

Note that the [u] has a sound very like a short [ah], so is redundant as far as the sound is concerned. It is also a relatively infrequent sound.

In fact for the right hand we want to [ou] near the [w](=[oo]) on the first finger, so we need the layout the other way round, with the [ou] on the left.

For the fingers, it would make it easier for the user to have the additional keys for the m, n, ng nasals and the th, sh and ch fricatives.

One possible embodiment of the invention comprises two 3×4 key or button arrays, each in a plane at approximately 90 degrees to the other, with the keys or buttons. The left 3×3 buttons are used by the thumb of the right hand, and conversely the right 3×3 buttons by the thumb of the right hand. The nine vowels of the thumb are supplemented by the semi-vowels W and Y, acting for vowels [oo] and [ou] and operated by the fingers. The fingers are used for all diphthongs, which start with [oo] or [ou] or end with [oo], [ou] or [-er]. When not in a diphthong, the schwa sound [er] is produced by the thumb.

For the right hand, the operation is as follows, whereas the left hand has the mirror image.

| | | | | | | 4^{th} | | |
|---|---|---|---|---|---|---|---|---|
| 1^{st} | | 2^{nd} | | 3^{rd} | | Finger | | |
| P/B | M | T/D | N | K/G | Ng | L | | |
| F/V | Th/Thv | S/Z | Sh/Zh | H | Ch/Chv | R | {close oversize brace} | Finger |
| W/oo | | -er | | | | Y/ee | | |
| ou | | er | | i | | | | |
| aw | | ah | | e | | | {close oversize brace} | Thumb |
| o | | u | | a | | | | |

If W, Y or -er are added to a vowel in the thumb, they override the vowel sound of the thumb. The L, R and ‘nasal’ keys colour a vowel sound if present. They are able to voice consonants, if present at the beginning of fricatives, or the end of plosives (i.e. when the sound is made).

9. Wrist mounted embodiment

In an alternative embodiment, the two arrays are mounted close together on a flexible mounting, which can be wrapped half around the wrist. Typically it is mounted around the side of the wrist away from the user, and operated by the other hand palm upwards, allowing an integral display on the side of the wrist towards the user to remain visible during operation.

10. Glove embodiments

In the glove embodiment of the input device, the keys are replaced by sensors on a glove in positions corresponding to 2nd and 3rd joints of each finger. The user taps consonants onto the sensors on the 3rd joint of each finger, and taps or slides their thumb over sensors on the 2nd joint of the first, second and third fingers (assuming right hand tapping onto a left hand or vice versa).

The “grooves” between adjacent fingers, are used for phonemes corresponding to the recessed keys mentioned above, with the exposed side of first/index and fourth/little finger for the [w] and [y] respectively for left hand glove (and right handed tapping).

11. Method of deafblind communication

The system can be used for direct communication with or between deafblind people. Potentially they can be receiving (sensing) with one hand (conventionally the left hand) at the same time as sending (tapping) with the other hand.

12. Production rules for other languages and for regional accents

The embodiments above allow for a variety of European languages. The two-keypad embodiment allows for 9 or more vowel sounds, and the maximum found is 11, excluding nasal vowels. One of the consonant keys may have to be set aside for nasalisation. Diphthongs can generally be dealt with in a similar way to English. The W with a vowel produces the effect of rounded lips on that vowel, which suggests its use for the umlaut in German.

English RP (received pronunciation) has 20 or 21 phonemes, see [1] page 153. Some 9 of these are always diphthongs in RP, see pages 165 to 173. There can be different production rules to produce regional accents or dialects. However preferred embodiments have a scheme with 11 pure sounds and a number of diphthongs produced by adding a short [ee] or [oo] to pure sound at its beginning or end, or by moving onto a brief central “schwa” sound at the end. The adding of short [ee] and [oo] for diphthongs can be used in many other European languages, for example for “mein” and “haus” in German or “ciudad” and “cuatro” in Spanish.

There will be slightly different production rules for consonants compared to English. The L is normally voiced in English. For French we will need to make a distinction between voiced and unvoiced L, for the difference between the allophones in “simple” and “seul”.

The production of R varies between languages and accents. The ‘r’ following a vowel is a colouring for American English and certain UK regional accents. For most continental European languages, the ‘r’ is produced at the back of the throat, e.g. a rolled uvular.

The upper row of buttons are further away from the palm than the bottom row, so that the finger can quickly curl to make affricatives such as the Pf or the German initial Z (pronounced [ts]). You have a longer time to stretch out your finger to produce an FP or ST since the pressing a plosive will just continue a gap in the sound.

It is possible to adjust the production rules to suit different languages. In English one can produce some diphthongs by moving the thumb into the central “schwa” position. Otherwise diphthongs can be produced by moving to or from a [oo] or an [ee] position in vowel space. (This corresponds to using a button to add a W or Y to the beginning or end of the vowel.)

13. Coding for typing

An scheme can be arranged corresponding closely to the phonetic scheme, so letters can be sounded out as they are typed. J would be sounded as in French ‘jamais’. C would be sounded as ‘ch’ in “loch”.

5 keys for the thumb give vowels A, E, I, O, U. These would be sounded as short vowels.

i

e

o u a

Any of these vowels can voice a consonant, thus

B=P+vowel

D=T+vowel

G=K+vowel

V=F+vowel

Z=S+vowel

The W can be covered by the first finger and Y by the little finger.

| 1^{st} | 2^{nd} | 3^{rd} | 4^{th} |
|---|---|---|---|
| P/B | T/D | K/G | L |
| F/V | S/Z | H | R |
| W | | | Y |

M=P+T

N=T+K

C=H+R

Q=K+W

X=K+S

J=S+H+Vowel

Note there would be a different arrangement for different languages. Thus for French, K and Q would interchanged because K is rare, and J and Z might also be interchanged. For German, F/V becomes V/W, the W position is used for umlaut, and V+S used for F perhaps.

Note that the ‘chords’ are only registered when the first key of one or more depressed keys is raised. This is a normal procedure for chordal keyboards. For example to type ‘SCH’ would the S to be raised before H+R are depressed, and these must in turn be raised before the H is depressed.

14. References

[1] J. D. O'Connor, “Phonetics”, Penguin, 1973 reprinted 1991.

1. A system comprising:
an input device,
an output device,
a processor to process the input received from the input device, to convert the input to a form suitable for output, and to output it on the output device; in which the input device:
includes a first means which the user of the system operates to indicate vowels or vowel sounds,
includes a separate second means which the user operates to indicate consonants or consonant sounds,
where a particular unvoiced consonant is indicated by a certain operation of the second means, and the corresponding voiced consonant is indicated by combining the same operation of the second means with the operation of the first means indicating any vowel; and in which possible forms of the output include:
a speech waveform as synthesised by the processor, for output through an audio output device;
characters for a one-handed serial tactile display device corresponding to the input device in having a third means to indicate vowels and a fourth means to indicate consonants, where a particular unvoiced consonant is indicated by a certain operation of the fourth means, and the corresponding voiced consonant is indicated by combining the same operation of the fourth means with the operation of the third means indicating any vowel;
a form for digital transmission to equipment local to another person, thence for output on the tactile display device or audio output device, for sensory reception of the communication by that person.

2. A system as claimed in claim 1, in which the input and corresponding output:
is essentially phonetic, in that there are sounds associated with the position or position of depression of thumb on the first means and fingers on the second means,
can distinguish the phonemes of a language, even when these are significantly more numerous than the letters of that alphabet, as in the case of English (around 44 phonemes versus 26 letters in the alphabet).

3. A system as claimed in any preceding claim, in which:
the sound from a plosive consonant is produced when the finger is moved away from the position indicating that consonant on the second means;
the presence of absence of a thumb on the first means indicates at that moment whether the plosive is voiced or not, respectively;
if the thumb is present throughout the period that the finger is in the consonant position, and both digits are moved away from, or released from, their positions simultaneously, a short schwa sound is produced, as would be normal following the voiced consonant at the end of a word;
the sound of a non-plosive consonant is produced while the finger is in the position indicating that consonant;
the presence of absence of a thumb at the beginning of a fricative consonant indicates whether a fricative consonant is voiced or not, thus allowing a change of vowel between that preceding the consonant and that following the consonant.

4. A system as claimed in any preceding claim, in which the vowels with composite sound (diphthongs or triphthongs) are produced:
by moving the thumb on the first means from one vowel position to another (typically to or from the schwa vowel position for English); or
by adding a ‘liquid’ consonant such as ‘y’ or ‘w’ at the beginning or end of the vowel or both, so for example ‘quite’ is produced by /k/ /w/ /ah/ /y/ /t/ and ‘quiet’ by /k/ /w/ /ah/ /er/ /t/ where /er/ stands for the schwa sound.

5. A system as claimed in any preceding claim, in which vowels can be modified or coloured by the addition of consonant finger indications on the second means, such as:
/w/ for rounded lips;
/m/, /n/ or /ng/ for nasalisation;
/r/ for either schwa endings or, in rhotic accents, for r-colouring;
/l/ for l-colouring;
/h/ for whispering the vowel—vowels are otherwise voiced.

6. A system as claimed in any preceding claim, in which:
the positions for consonants are arranged in an order and juxtaposition corresponding to tongue positions in the mouth for their formation in speech, ranging from lip position (e.g. for /p/) to the back of the mouth (e.g. for /k/);
the positions for the vowels are arranged in a two-dimensional arrangement according to position of a conventional ‘vowel diagram’, in which the two axes represent front-back and open-closed respectively, with the schwa sound centrally.

7. A system as claimed in any preceding claim, in which particular positions of thumb on the first means, finger on the second means, and combinations thereof, are chosen for particular letters of the alphabet, thus allowing the system to be used for alphabetic input, but with a close correspondence to the phonetic scheme such that each letter has a unique sound, which can be emitted as an option.

8. A system as claimed in any preceding claim, in which the system can operate in a non-alphabetic mode for input of non-alphabetic characters, e.g. numerals.

9. A system as claimed in any preceding claim, in which the input device uses an array of keys or buttons for the consonant, and a second array for the vowels.

10. A system as claimed in any of claims 1 to 8, in which the first means is a tactile surface for detecting movement, position, or depression of the thumb in a 2-dimensional vowel space, with axes representing open/close and front/back tongue positions.

11. A system as claimed in any preceding claim, in which the input device is mounted on a wrist in such a way that a small visual display such as an LCD, also mounted on the wrist, can be seen whilst the input device is being operated.

12. A system as claimed in any preceding claim, in which a visual display provides indicia for the phoneme positions, to help a novice to use the input device.

13. A system as claimed in any preceding claim, in which the back end of a speech recognition engine is used to convert the phoneme stream produced by the input device into a stream of ordinary text, suitable for display on an alphanumeric display device.

14. A system as claimed in any preceding claim, in which the front end of a speech recognition engine is used to convert the speech produced by a speaker into a phoneme stream suitable for display through the tactile output device.

15. A system as claimed in any preceding claim, in which the tactile device has four or more pines for the first means and two or more pins for the second means, where different said pins move or vibrate corresponding to different vowels or consonant input on the input device in corresponding positions under thumb or fingers.

16. A system as claimed in any of claim 1 to 14, in which the first means is a tilting device allowing the thumb to detect the position of a received vowel in vowel space, corresponding to the vowel space mentioned in claim 10.

17. A system as claimed in claim in any preceding claim, in which the sensors (for input) or vibrators (for output) or both are mounted in a glove.

18. A system as claimed by any preceding claim, in which the sound output from the synthesiser is adjusted for particular phonemes in various languages and accents.
